(19) United States
(12) Patent Application Publication
(10) Pub. No.: US 2011/0078649 A1
(43) Pub. Date: Mar. 31, 2011

(54) WAFER LAYOUT ASSISTING METHOD AND SYSTEM

(76) Inventor: Ssu-Pin Ma, San Jose, CA (US)

(21) Appl. No.: 12/571,212

(22) Filed: Sep. 30, 2009

(51) Int. Cl. G06F 17/50

(52) U.S. Cl. 716/139; 716/126

(57) ABSTRACT

A wafer layout assisting method is used to assist a circuit designer to estimate the layout related parameter during a circuit designing process. The wafer layout assisting method includes the following steps. A circuit information file is read. A graphic user interface (GUI) is generated according to the circuit information file. A coarse layout arrangement input by a user is received. It is determined whether the coarse layout arrangement is finished or not. A layout related parameter is generated according to device types, device parameters, and the coarse layout arrangement, if the coarse layout arrangement is finished. The circuit designer may increase an accuracy of a circuit simulation result by appropriately utilizing the layout related parameters. Through the wafer layout assisting method, the layout related parameter after the layout is performed may be pre-estimated, thus reducing a difference between the circuit simulation results before and after the layout is performed.

### BACKGROUND

1. Field of the Invention

The invention relates to an assisting method, and more particularly to a wafer layout assisting method.

2. Related Art

In a conventional circuit, an experiment may be performed on a breadboard or a printed circuit board (PCB) in advance to verify a circuit designing result, but this cannot be realized in an integrated circuit (IC). Therefore, in order to improve a yield and lower a cost during the production of the IC, when designing the circuit, a designer simulates performances of the circuit by using simulation software. The manufacture of the IC is performed after the simulation is finished.

A main function of the circuit simulation software is simulating a physical phenomenon of an electronic device. In the software, the user needs to define parameters of devices and connection relations of the devices in a circuit, and adds a testing signal and selects an analysis method, such that the user obtains an electric response of the circuit. For example, for a metal oxide semiconductor field-effect transistor (MOSFET, referred to as MOS transistor for short), the parameters defined by the user may comprise a semiconductor type, a length, a width, and a finger number of a gate.

As the semiconductor technology is increasingly developed, the process of the IC is continuously developed accordingly. During a process of developing from a deep submicron meter process to a current nanometer process, as the size of the device is continuously reduced, many undesired effects are generated, in which many undesired effects are related to a device layout and relative positions. Here, the description is given by taking a length of diffusion (LOD) effect parameter as an example. The LOD effect is also called a shallow-trench-isolation stress effect, which is a characteristic of the MOS transistor and is related to the length from the gate to an edge of the diffusion area. Here, usually layout related parameters SA and SB are required, so as to enhance an accuracy of the circuit simulation, and the parameters SA and SB are respectively distances from the gate of the transistor to the two edges of the diffusion area. Usually, in the device layout, a plurality of transistors shares the same diffusion layer, so the relative positions and the layout method of the transistors may greatly change the parameters. The device layout and the relative positions are usually determined in a layout stage after the circuit simulation. During the circuit simulation stage, the layout related parameters cannot be known, such that effects on the circuit cannot be known.

### SUMMARY

In view of the above problems, the invention is a wafer layout assisting method and a system thereof. The method is used to assist a circuit designer to estimate at least one layout related parameter during a circuit designing process.

The wafer layout assisting method comprises the following steps. Read the circuit information file. Wherein, the circuit information file comprises a plurality of devices, parameters of the devices, and connection relations of the devices. Generate a graphic user interface (GUI) according to the circuit information file, for allowing a user to perform a coarse layout arrangement. Receive at least one coarse layout arrangement input by a user. Determinate whether the coarse layout arrangement is finished or not. Generate at least one layout related parameter of the devices according to the coarse layout arrangement, if the coarse layout arrangement is finished.

The invention further provides a wafer layout assisting system. The system may comprises a file reading module, an interface generation module, an instruction receiving module, a determination module, and a parameter generation module.

The file reading module may be used to read a circuit information file, in which the circuit information file comprises a plurality of devices, a plurality of device parameters corresponding to the devices, and connection relations of the devices. The interface generation module may used to generate a GUI according to the circuit information file. The instruction receiving module may be used to receive a coarse layout arrangement input by a user. The determination module may be used to determine whether the coarse layout arrangement is finished or not. The parameter generation module may be used to generate a layout related parameter of the devices according the coarse layout arrangement, if the coarse layout arrangement is finished.

To sum up, in the wafer layout assisting method according to the invention, the layout related parameter after the layout is performed may be pre-estimated by using a simplified coarse layout arrangement before the layout is performed, so as to consider the layout related parameters during the circuit simulation, thereby reducing a difference between the circuit simulation results before the layout is performed and the post-layout simulation results.

### BRIEF DESCRIPTION OF THE DRAWINGS

The invention will become more fully understood from the detailed description given herein below for illustration only, and thus are not limitative of the invention, and wherein:

FIG. 1 illustrates a flow chart of a first embodiment of the invention;

FIG. 2A illustrates a net list;

FIG. 2B illustrates a schematic;

FIG. 2C illustrates a graphic interface generated according to FIG. 2B;

FIG. 2D illustrates a layout arrangement input according to the graphic interface;

FIG. 2E illustrates a circuit device list after a layout related parameter is written;

FIG. 3 illustrates a flow chart of a second embodiment of the invention;

FIG. 4 illustrates a flow chart of a third embodiment of the invention; and

FIG. 5 illustrates a block diagram of a system according to the invention.

### DETAILED DESCRIPTION

The detailed features and advantages of the invention may be described below through the following embodiments, and the content of the detailed description is sufficient for persons skilled in the art to understand the technical content of the invention and to implement the invention accordingly. Based upon the content of the specification, the claims, and the drawings, one of ordinary skill in the art can easily understand the relevant objectives and advantages of the invention. The following illustrations and examples may be intended to describe various embodiments of the invention in further details but may not be intended to limit the scope of various embodiments in any way.

A method according to the invention may be applied by tool program adopted in a computer or a server or other electronic apparatuses having a computing function. The tool program is not limited to any program language, and the computer is not limited to any platform or operating system. The file may be read from or saved to memory, optical storage medium or hard disk. The output of the method may be displayed on a monitor. Some steps of the method may be executed by a processor.

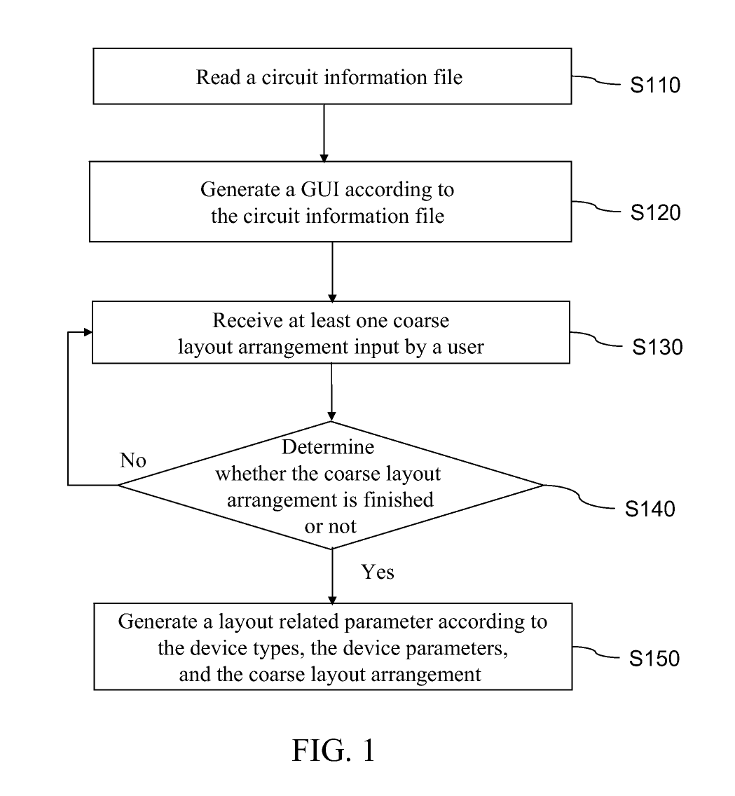

FIG. 1 illustrates a flow chart of a first embodiment of the invention. Referring to FIG. 1, the method according to the embodiment comprises the following steps. Read the circuit information file (S110). The circuit information file may comprise a plurality of devices, parameters of the devices, and connection relations of the devices. Generate a graphic user interface (GUI) according to the circuit information file (S120), for allowing a user to perform a coarse layout arrangement. Receive at least one coarse layout arrangement input by a user (S130). Determinate whether the coarse layout arrangement is finished or not (S140). Generate a layout related parameter of the devices according to the coarse layout arrangement (S150) if the coarse layout arrangement is finished.

In the Step S110, the circuit information file may be a schematic or a net list. The schematic or the net list comprises a plurality of devices, a plurality of device parameters corresponding to the devices, and a plurality of connection relations. The devices may comprise an MOSFET, a bipolar junction transistor (BJT), a resistor, a capacitor, an inductor, a diode, a voltage source, a current source, a signal source, a ground, and so on. The devices correspond to at least one device parameter. Take metal oxide semiconductor for example, the device parameters comprise a length, a width, and a finger number of a gate, and the like.

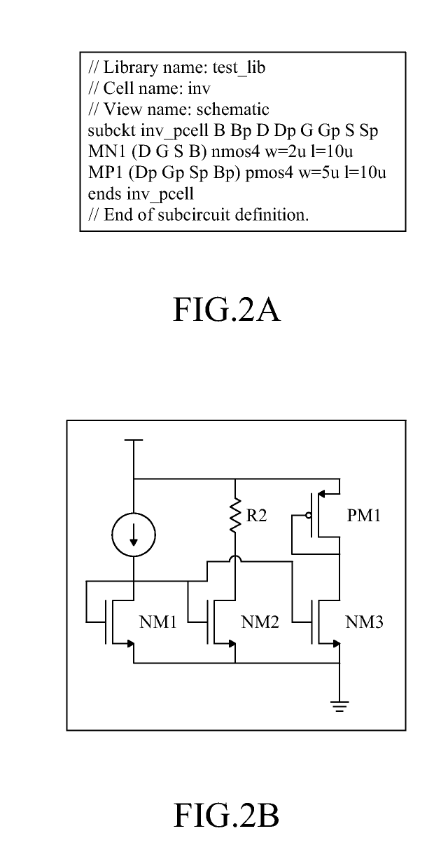

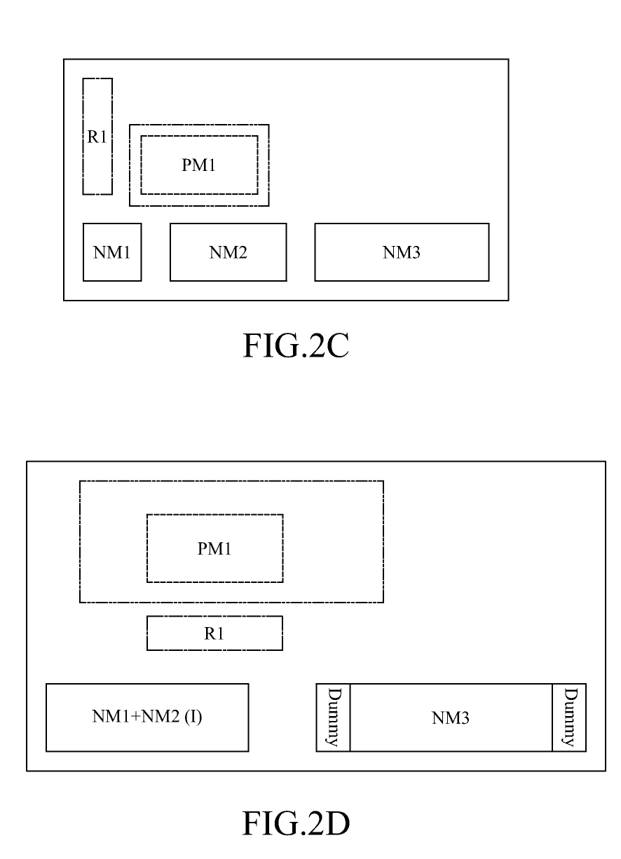

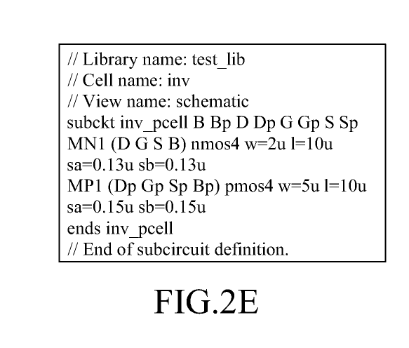

FIG. 2A illustrates a net list. Referring to FIG. 2A, the device parameters in the net list are, for example, device parameters used by a Berkeley short-channel insulated-gate field-effect transistor (IGFET) model (BSIM) circuit model commonly used in the design of the circuit recently. The circuit is composed of a P-type metal oxide semiconductor and an N-type metal oxide semiconductor. The net list comprises device names, device parameters, and connection relations of the devices. FIG. 2B illustrates a schematic. The circuit comprises a current source, a resistor R1, three N-type metal oxide semiconductors NM1, NM2, and NM3, a P-type metal oxide semiconductor PM1, and a ground net.

In the Step S120, the graphic interface displays geometrical shapes of the devices based on relative sizes according to the parameters (for example, length and width) of the devices. The device names may be displayed in the graphic interface. In addition, in the graphic interface, different colors may be marked for the devices having different attributes. The user may quickly differentiate the devices having different attributes according to the different colors. The user interface may comprise instructions of determining that the layout is finished, storing the layout graphic, or reading the layout graphic etc.

In the single embodiment or in some embodiments, all the devices may be classified into physical devices and non-physical devices. The physical devices comprise devices which could be formed on the wafer after the semiconductor process, such as the metal oxide semiconductor FET (MOSFET), the BJT, the resistor, the capacitor, the inductor, and the diode, and the non-physical devices may comprise voltage sources, current sources, signal sources, grounds, ideal resistors, ideal capacitors, ideal inductors, ideal electronic devices, and parasitic electronic devices etc. Next, the physical devices may be displayed in the graphic interface

FIG. 2C illustrates a graphic interface generated according to FIG. 2B. In the graphic interface, the physical devices comprise a resistor R1, three N-type metal oxide semiconductors NM1, NM2, and NM3, and a P-type metal oxide semiconductor PM1. In the drawing, the P-type metal oxide semiconductor PM1 also has a corresponding well area displayed.

In the single embodiment or in some embodiments, when the circuit information file has a multi-hierarchy structure, the user may be allowed to select whether to perform the coarse layout arrangement for the entire multi-hierarchy structure or perform the coarse layout arrangement for a specific sub-circuit or a sub-block. Here, the already finished coarse layout arrangement may be accepted as a part of the new coarse layout arrangement.

In the Step S130, at least one coarse layout arrangement input by the user is received. The coarse layout arrangement input by the user may comprise device positions and placing angles of the devices. In the single embodiment or in some embodiments, the coarse layout arrangement further comprises adding at least one dummy device around at least one device. In the single embodiment or in some embodiments, the coarse layout arrangement further comprises combining more than one device in one active region. The active region of a MOSFET is called as Oxide Diffusion (OD) area or Oxide Definition (OD) area. In the single embodiment or in some embodiments, the coarse layout arrangement further comprises combining more than one device in an interleaving manner. In the single embodiment or in some embodiments, the coarse layout arrangement further comprises enlarging the well area of at least one device.

In the Step S130, the user may input the coarse layout through a mouse, a keyboard, a touch screen, or other input apparatuses.

In the Step S130, the user could make arrangements of physical devices. In another word, the user could select, move, rotate, combine, and/or separate the physical devices, so as to achieve the coarse layout arrangement.

In the single embodiment or in some embodiments, at least one device could be removed from the coarse layout. In this case, the user may not want to decide the layout relationship of this at least one device to other devices in this coarse layout at that time.

In the Step S130, in the single embodiment or in some embodiments, one or more user interfaces may be generated at the same time. Information of the devices may be displayed in the user interface. The user interface provides a convenient input interface for the user, so as to achieve the coarse layout arrangement.

In the Step S130, in the single embodiment or in some embodiments, the user interface has a text input blank, a pull-down window, a click button, or other input manners.

In the Step S130, in the single embodiment or in some embodiments, when the user selects a certain device, the related device may be displayed in the GUI or the user interface.

In the Step S130, in the single embodiment or in some embodiments, when the user selects a certain device, the device may be highlighted in the circuit information file.

FIG. 2D illustrates the coarse layout arrangement input according to the graphic interface. Referring to FIG. 2D, in this embodiment, the direction of the resistor R1 is rotated by 90 degrees and the N-type metal oxide semiconductors NM1 and NM2 are combined in the interleaving manner. The combination of NM1 and NM2 is one of combination relations of devices. The dummy devices are added to two sides of the N-type metal oxide semiconductor NM3, and the well of the P-type metal oxide semiconductor PM1 is enlarged.

In the Step S130, in the single embodiment or in some embodiments, the user assigns a connection line between specific end points. When the layout related parameter is calculated, the layout related parameter related to the connection line on the connection line is calculated.

Next, the Step S140 is executed. After the circuit designer finishes the coarse layout arrangement, an instruction indicating that the coarse layout arrangement is finished is transmitted according to the user interface. When the instruction indicating that the coarse layout arrangement is finished is received, it is determined that the coarse layout arrangement is finished.

In the Step S150, in the single embodiment or in some embodiments, when the coarse layout arrangement is finished, the layout related parameter is generated according to the coarse layout arrangement. The layout related parameter comprises an LOD effect parameter, a well proximity effect parameter, and the like. For a BSIM4 circuit model, the method for generating the LOD effect parameter may be obtained with reference to “Chapter 13: Stress Effect Model” in “BSIM4.4.0 Manual Copyright© 2004 UC Berkeley”.

Here, the referred layout related parameter could be a relative distance, a stacking area, or width-length ratio during a semiconductor process.

In the single embodiment or in some embodiments, in the Step S150, at least one layout related parameter is generated according to the device types, the device parameters, and the combination relations.

In the single embodiment or in some embodiments, if the user assigns the connection line between specific end points in the Step S130, a parasitic capacitance and a parasitic resistance of the connection line may be calculated.

The layout related parameter may be generated by measuring a distance between specific edges.

The layout related parameter may be generated in a look-up table or a formula assisting manner.

The layout related parameter may be provided for the user. The user inputs the layout related parameter in the circuit information file, and performs a circuit simulation.

In the single embodiment or in some embodiments, the layout related parameter may be updated into the circuit information file. The user may perform the circuit simulation by using the updated circuit information file.

In the single embodiment or in some embodiments, the location information of devices in the coarse layout can be extracted. This location information could be provided for the initial devices placement of a further layout process.

Referring FIG. 2E, it is a result after the layout related parameter is updated in circuit information file as shown in FIG. 2A.

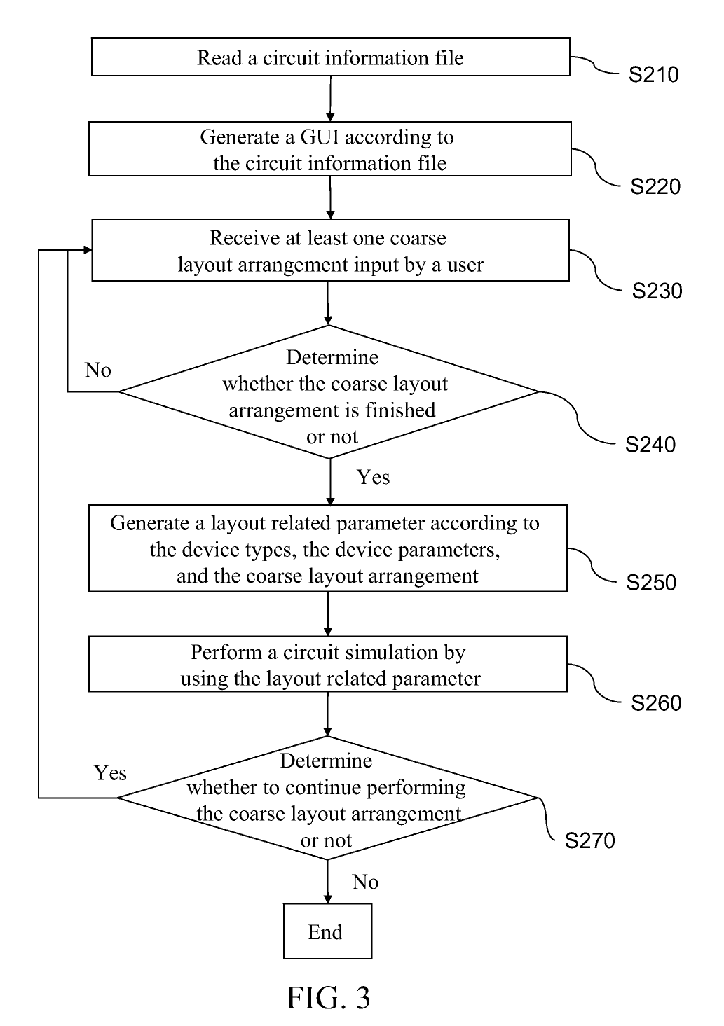

FIG. 3 illustrates a flow chart of a second embodiment of the invention. Referring to FIG. 3, the method according to the embodiment comprises the following steps. Read the circuit information file (S210). The circuit information file comprises a plurality of devices, parameters of the devices, and connection relations of the devices. Generate a graphic user interface (GUI) according to the circuit information file (S220), for allowing a user to perform a coarse layout arrangement. Receive at least one coarse layout arrangement input by a user (S230). Determinate whether the coarse layout arrangement is finished or not (S240). If the coarse layout arrangement is finished, the following steps are executed. Generate a layout related parameter of the devices according to the coarse layout arrangement (S250). Perform a circuit simulation by using the layout related parameter (S260). Determine whether to continue performing the coarse layout arrangement or not (S270), and if it is determined to continue performing the coarse layout arrangement, the process returns to the Step (S230) to receive the coarse layout arrangement input by the user again.

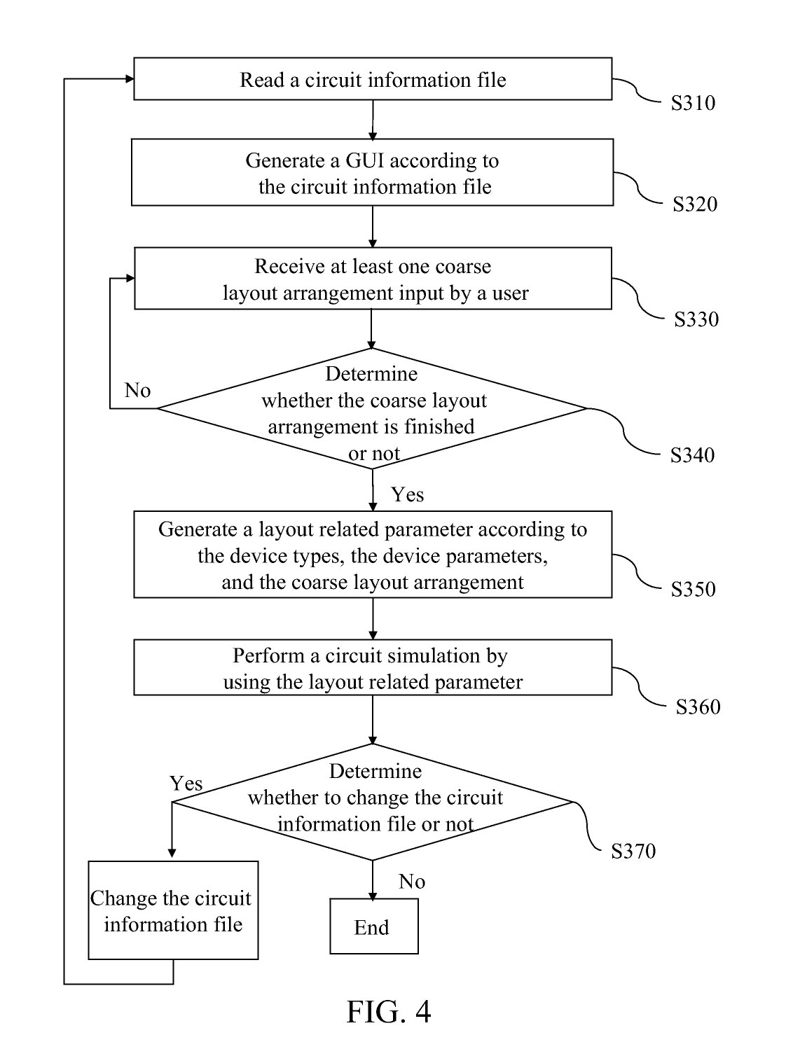

FIG. 4 illustrates a flow chart of a third embodiment of the invention. Referring to FIG. 4, the method according to the embodiment comprises the following steps. Read the circuit information file (S310). The circuit information file may comprise a plurality of devices, parameters of the devices, and connection relations of the devices. Generate a graphic user interface (GUI) according to the circuit information file (S320), for allowing a user to perform a coarse layout arrangement. Receive at least one coarse layout arrangement input by a user (S330). Determinate whether the coarse layout arrangement is finished or not (S340). If the coarse layout arrangement is finished, the following steps are executed. Generate a layout related parameter of the devices according to the coarse layout arrangement (S350). Perform a circuit simulation by using the layout related parameter (S360). Determine whether to change the circuit information file or not (S370), and if it is determined that the circuit information file needs to be changed, the circuit information file is appropriately modified, and the process returns to the Step (S310) to read the updated circuit information file.

In the single embodiment or in some embodiments, after the process returns to the Step (S310), and when the Step (S320) is subsequently executed, the former layout arrangement may be searched. After the former layout arrangement is compared with the newly read circuit information file, a new layout arrangement is generated. In the new layout arrangement, the increased devices may be highlighted by using specific signs.

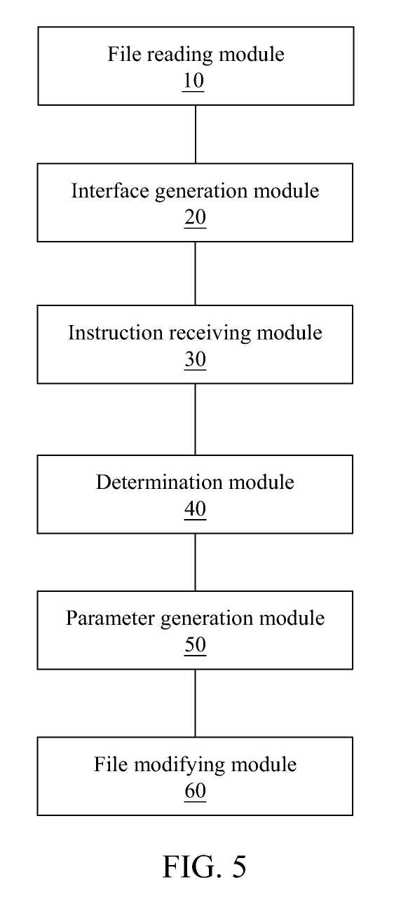

In the single embodiment or in some embodiments, the invention further provides a wafer layout assisting system. Referring to FIG. 5, the system may comprises a file reading module 10, an interface generation module 20, an instruction receiving module 30, a determination module 40, and a parameter generation module 50.

The file reading module 10 can be used to read a circuit information file, in which the circuit information file comprises a plurality of devices, a plurality of device parameters corresponding to the devices, and connection relations of the devices. The interface generation module 20 can used to generate a GUI according to the circuit information file. The instruction receiving module 30 can be used to receive a coarse layout arrangement input by a user. The determination module 40 can be used to determine whether the coarse layout arrangement is finished or not. The parameter generation module 50 can be used to generate a layout related parameter corresponding to the devices according the coarse layout arrangement, if the coarse layout arrangement is finished.

In the single embodiment or in some embodiments, in the file reading module 10, the circuit information file may be a schematic.

In the single embodiment or in some embodiments, in the file reading module 10, the circuit information file may be a net list.

In the single embodiment or in some embodiments, in the interface generation module 20, a plurality of physical devices is selected, and a graphic interface is generated according to the circuit information file of the plurality of physical devices.

In the single embodiment or in some embodiments, in the instruction receiving module 30, instructions input by the user through a keyboard are received.

In the single embodiment or in some embodiments, in the instruction receiving module 30, instructions input by the user through a mouse are received.

In the single embodiment or in some embodiments, in the instruction receiving module 30, physical devices can select, move, rotate, combine, and separate by the user are received, so as to achieve the coarse layout arrangement.

In the single embodiment or in some embodiments, in the instruction receiving module 30, at least one distance between at least two devices is changed by a user.

In the single embodiment or in some embodiments, in the instruction receiving module 30, at least one dummy device is added to at least one of physical devices.

In the single embodiment or in some embodiments, in the determination module 40, a signal indicating that the arrangement is finished of the user is accepted, in which the signal indicating that the arrangement is finished of the user may be generated by clicking a specific button or inputting a text instruction by the user.

In the single embodiment or in some embodiments, in the parameter generation module 50, at least one layout related parameter is generated according to the types of devices, the parameters of devices, and the combination relations of devices.

In the single embodiment or in some embodiments, in the parameter generation module 50, the layout related parameter comprises an LOD effect parameter.

In the single embodiment or in some embodiments, in the parameter generation module 50, the layout related parameter comprises a well proximity effect parameter.

In the single embodiment or in some embodiments, in the parameter generation module 50, the layout related parameter comprises a parasitic capacitance and a parasitic resistance of a connection line.

In the single embodiment or in some embodiments, the system further comprises a file modifying module 60, used to add the layout related parameter generated by the parameter generation module 50 to the circuit information file.

In the single embodiment or in some embodiments, the system further comprises a file modifying module 60, used to add at least one layout related parameter generated by the parameter generation module 50 to the circuit information file, and store the circuit information file as a new circuit information file.

In the single embodiment or in some embodiments, the location information of devices in the coarse layout can be extracted. This location information could be provided for the initial devices placement of a further layout process.

In the wafer layout assisting method, and the wafer layout assisting system according to the present invention, at least one layout related parameter may be pre-estimated by using a simplified coarse layout arrangement before the layout is performed, so as to consider the layout related effects during a circuit simulation, thereby reducing a difference between the pre-layout circuit simulation results and the post-layout circuit simulation results.

What is claimed is:

1. A wafer layout assisting method, comprising:
reading a circuit information file, wherein the circuit information file comprises a plurality of devices, a plurality of parameters of the devices and a plurality of connection relations of the devices;
generating a graphic user interface (GUI) according to the circuit information file;
receiving at least one coarse layout arrangement input by a user;
determining whether the coarse layout arrangement is finished or not; and
generating at least one layout related parameter of the devices according to the coarse layout arrangement, if the coarse layout arrangement is finished.

2. The wafer layout assisting method according to claim 1, wherein the step of generating a GUI comprises selecting a plurality of physical devices, and generating a graphic interface according to the circuit information file of the physical devices.

3. The wafer layout assisting method according to claim 2, wherein the step of receiving at least one coarse layout arrangement comprises receiving the plurality of arrangement of physical devices and a plurality of combination relations of the devices from the user.

4. The wafer layout assisting method according to claim 3, wherein the step of generating at least one layout related parameter of the devices comprises generating at least one layout related parameter of the devices according to the parameters of devices, and the combination relations of the devices.

5. The wafer layout assisting method according to claim 1, wherein the step of receiving at least one coarse layout arrangement comprises adding at least one dummy device to the at least one of devices.

6. The wafer layout assisting method according to claim 1, wherein the step of determining whether the coarse layout arrangement is finished or not comprises receiving a signal indicating that the coarse layout arrangement is finished input by the user is accepted.

7. The wafer layout assisting method according to claim 1, further comprising adding the layout related parameter to the circuit information file.

8. A wafer layout assisting system, comprising:
a file reading module, used to read a circuit information file, wherein the circuit information file comprises a plurality of devices, a plurality of device parameters corresponding to the devices, and connection relations of the devices;
an interface generation module, used to generate a graphic user interface (GUI) according to the circuit information file;
an instruction receiving module, used to receive at least one coarse layout arrangement input by a user;
a determination module, used to determine whether the coarse layout arrangement is finished or not; and
a parameter estimation module, used to estimate a layout related parameter of the devices according to the coarse layout arrangement, if the coarse layout arrangement is finished.

9. The wafer layout assisting system according to claim 8, wherein in the file reading module, the circuit information file is a schematic.

10. The wafer layout assisting system according to claim 9, wherein in the interface generation module, a plurality of physical devices is selected, and a graphic interface is generated according to the circuit information file of the plurality of physical devices.

11. The wafer layout assisting system according to claim 9, wherein in the instruction receiving module, a plurality of physical devices arranged by the user are received, so as to achieve the coarse layout arrangement.

12. The wafer layout assisting system according to claim 8, wherein in the file reading module, the circuit information file is a net list.

13. The wafer layout assisting system according to claim 8, wherein in the instruction receiving module, at least one dummy device is added to the at least one of devices.

14. The wafer layout assisting system according to claim 8, wherein in the instruction receiving module, at least one distance between at least two devices is changed by a user.

15. The wafer layout assisting system according to claim 8, wherein in the parameter generation module, the layout related parameter comprises a length of diffusion (LOD) effect parameter.

16. The wafer layout assisting system according to claim 8, wherein in the parameter generation module, the layout related parameter comprises a well proximity effect parameter.

17. The wafer layout assisting system according to claim 8, wherein in the parameter module, the layout related parameter comprises a parasitic capacitance and a parasitic resistance of a connection line.

18. The wafer layout assisting system according to claim 8, further comprising a file modifying module, used to add the layout related parameter generated by the parameter generation module to the circuit information file.
